(19) United States
(12) Patent Application Publication
(10) Pub. No.: US 2026/0162077 A1
(43) Pub. Date: Jun. 11, 2026

(54) METHOD AND SYSTEM FOR ASSISTING IN THE OPERATIONAL DECISION-MAKING OF AN AIRCRAFT

(71) Applicants: AIRBUS SAS, Blagnac (FR); AIRBUS OPERATIONS SAS, Toulouse (FR)

(72) Inventors: Nathalie COURMONT, Toulouse (FR); Julien HOEPFFNER, Toulouse (FR); Olivier FERRAN, Blagnac (FR)

(73) Assignees: AIRBUS SAS, Blagnac (FR); AIRBUS OPERATIONS SAS, Toulouse (FR)

(21) Appl. No.: 19/319,358

(22) Filed: Sep. 4, 2025

(30) Foreign Application Priority Data
Sep. 5, 2024 (FR) 2409441

(51) Int. Cl. G06Q 10/20; G07C 5/00; G07C 5/08

(52) U.S. Cl. CPC G06Q 10/20; G07C 5/006; G07C 5/0841

(57) ABSTRACT

A method for assisting in the operational decision-making of an aircraft is executed by three computers during a current mission. The first computer automatically determines, as a function of fault information, a technical status of the aircraft and of a minimum equipment list, one or more affected MEL items and, for each item, one or more applicable dispatch conditions. The second computer automatically determines, as a function of the previous items provided by the first computer and of a set of future missions to be distributed among a fleet of aircraft, a proposed scenario (including, in the case of dispatch under one or more MEL items, a selection of dispatch conditions for each affected MEL item). The third computer receives a decision from the pilot to accept or refuse the proposed scenario and, in the event of acceptance, triggers completion of some tasks in the aircraft and updates the logbook.

### TECHNICAL FIELD

The field of the invention is that of managing the operation of aircraft, particularly when the aircraft experience a technical fault during a current mission that could affect future missions.

More specifically, the present invention relates to a method and a system for assisting in the operational decision-making of an aircraft, as well as a computer program product for implementing such a method.

### PRIOR ART

Within the context of the daily operations of an aircraft, technical faults can occur that can affect the completion of missions (i.e., flights) by the aircraft. Indeed, for safety reasons, before an aircraft takes off to complete a new mission, the pilot (captain) must ensure that the various equipment of this aircraft is functioning properly before deciding whether or not to authorise the “dispatch” of the aircraft for this new mission.

Sensors and control devices are used to assist the pilot in completing diagnostics for the aircraft. The pilot is thus notified when a technical fault (or breakdown) is detected. This can be a new fault or even a fault that was already detected during a previous mission but could not be corrected during maintenance, for example, due to a lack of time or resources. A technical fault is understood to mean the fact that an item of equipment or a function of the aircraft is inoperative, i.e., does not satisfactorily fulfil the role for which it was designed, irrespective of the reason (for example, does not operate at all, does not perform one or more of the functions for which it was designed, does not always operate within the operating limits or tolerances for which it was designed, is unavailable due to a primary fault, etc.).

In order to prevent each fault from resulting in costly aircraft downtime, the pilot has a document (in paper or electronic form) called the MEL (Minimum Equipment List). The content of the MEL identifies the conditions under which the aircraft can be operated despite the existence of one or more faults, while ensuring that the safety of the aircraft is not compromised. Thus, the MEL concept allows an aircraft to continue to be used with certain instruments, equipment or functions that are inoperative or missing for a limited period (with the duration varying depending on the severity of the consequences) until repairs can be carried out.

For a new mission, the MEL must be applied before the start of the flight (before the taxi phase or before the take-off phase of the aircraft, depending on the current regulations) and must be accepted by the pilot.

The MEL lists all the equipment or functions that can be inoperative for a new mission (new flight) to be undertaken. Each item on the list (also called “MEL item”) includes an identifier and a description of a technical fault (concerning an inoperative item of equipment or function of the aircraft) and defines a maximum permissible duration of the fault status, a number of occurrences that the equipment or the function has been the subject of the fault, a minimum number of occurrences required for the exempted flight and, where applicable, one or more dispatch conditions for the aircraft for the new mission. Each MEL item can also define specific procedures that must be applied by the crew when the associated fault is present.

The dispatch conditions can include the status of one or more items of equipment or functions, for example, the operational status (operational or out of service), the functional position (open, closed, on, off, etc.) or its control selection status (on, off, open, closed, etc.). The dispatch conditions can also include a logical combination of the statuses of several items of equipment or functions. The dispatch conditions can also refer to operational usage limitations such as a limited altitude or flight level or a penalty on aircraft performance.

In a conventional use of the MEL, before the aircraft departs on a new mission, the following steps must be implemented by a maintenance operator during the Turn Around Time (TAT) of the aircraft to ensure that the aircraft can depart in an airworthy condition:
detection of the fault (for example, by ECAM (Electronic Centralised Aircraft Monitoring) alerts, observations (by the crew or the maintenance personnel), etc.);
reporting of the fault: any inoperative equipment or function of the aircraft must be reported in the aircraft logbook by the crew or the maintenance personnel;
identification of the MEL item associated with the detected fault by matching the detected fault with the various entries in the MEL;
review of the dispatch conditions defined in the identified MEL item;
decision to repair or dispatch the aircraft based on the identified MEL item and the technical status of the aircraft (including technical data relating to the operation of equipment and functions of the aircraft); and
in the event of dispatch under the identified MEL item, recording the identified MEL item and one (or more) of the selected dispatch conditions in the logbook.

The MEL items can correspond to one of the following three types of dispatch status:
a dispatch status called “GO”, which corresponds to an unconditional dispatch, but with a time limit;
a dispatch status called “GO IF”, with one or more dispatch conditions corresponding to one or more conditions that must be met to allow the aircraft to dispatch; and
a dispatch status called “NO GO”, which corresponds to a situation in which the aircraft must be repaired and cannot dispatch under MEL.

Communication with an air operations officer (flight dispatcher) or an agent at the maintenance control centre (MCC) of the operator can help the pilot assess the MEL item and decide whether or not to continue the flight. However, the pilot is responsible for making the final decision for the new mission (dispatch status decision: “NO GO”, “GO” or “GO IF”) and, for example, to accept the dispatch of the aircraft under the identified MEL item (for the “GO” or “GO IF” case).

In the “GO IF” case, for the first dispatch (first mission) of the aircraft under the identified MEL item, all the dispatch conditions and associated limitations must be taken into account and all the relevant maintenance (m) and operational (o) procedures must be applied to maintain an acceptable level of safety for the operation of the aircraft.

Also in the “GO IF” case, for the subsequent missions of the aircraft under the same identified MEL item, the crew must check that any MEL item open in the logbook is within the repair interval window and that this window will not be exceeded during the next mission. For each subsequent mission, when the dispatch conditions are accepted by the pilot, all the necessary operational procedures also must be applied.

It should be noted that the MEL is intended to be applied before the aircraft departs on a new mission. It is therefore not intended to be applied in the event of a fault during a flight.

According to a current solution, when a technical fault is detected during a flight (i.e., during a current mission), a detailed description of the detected fault is recorded in the logbook, and the flight dispatcher and/or the maintenance control centre (MCC) of the operator is/are notified so that a mechanic can intervene upon the arrival of the aircraft. More specifically, the ground mechanic must wait for the aircraft to arrive in order to analyse and assess the technical status of the aeroplane during the aircraft turn around time (TAT) and to consult the MEL in relation to the fault detected during the flight (which has just ended), in order to, on the one hand, assess the possibility of dispatch under an MEL item for a subsequent mission and, on the other hand, to carry out maintenance tasks (m) defined in the aircraft maintenance manual (AMM) in order to configure the aeroplane for the next mission. The pilot for the subsequent mission shall also, in the event of dispatch under an MEL item, carry out operational procedures (o) in certain flight phases, in addition to the standard operating procedures (SOP).

It appears that the aforementioned current solution for assessing the possibility of dispatch under an MEL item for a subsequent mission, in the event that a technical fault has been detected during the last mission, is satisfactory but it needs to be improved further.

Notably, a solution needs to be provided offering at least one of the following advantages over the aforementioned current solution, in the event that a technical fault is detected in flight (i.e., during a current mission):
overcome the need for a mechanic and avoid affecting the turn around time (TAT) of the aircraft when assessing the possibility of dispatch under an MEL item for the subsequent missions of the aircraft;
allow the assessment of the possibility of dispatch under an MEL item to be anticipated;
allow the operator (airline) to anticipate the maintenance or the adjustment of flight schedules (missions) for its fleet of aircraft;
overcome (partially or completely) the need for a mechanic to reconfigure the aircraft in the event of dispatch under an MEL item for the subsequent missions of the aircraft; and
facilitate the analysis of the situation by the pilots for the subsequent flights of the aircraft when they prepare for said subsequent flights.

### DISCLOSURE OF THE INVENTION

A method is proposed for assisting in the operational decision-making of an aircraft, the method being executed during a current mission of the aircraft and comprising:
in a first computer, implemented in the aircraft or in an electronic flight bag or on the ground, and comprising electronic circuitry:
   receiving fault information recording at least one technical fault of the aircraft;
   for each recorded technical fault, determining, by consulting a database comprising a minimum equipment list, one or more items from the minimum equipment list, called MEL items, affected by said technical fault, with each affected MEL item relating to an inoperative item of equipment or function of the aircraft and defining one or more dispatch conditions for the aircraft for a possible future mission;
   receiving a technical status of the aircraft, including technical data relating to the operation of equipment or functions of the aircraft; and
   for each affected MEL item, determining, based on the technical status of the aircraft, one or more applicable dispatch conditions from among the one or more dispatch conditions defined in said affected MEL item;
in a second computer, installed on the ground and comprising electronic circuitry:
   receiving, from the first computer, the one or more applicable dispatch conditions for each affected MEL item; and
   determining a proposed scenario based, on the one hand, on the one or more dispatch conditions applicable for each affected MEL item and, on the other hand, on a set of future missions to be distributed among a fleet of aircraft including said aircraft, said proposed scenario comprising: a decision to repair the aircraft or to dispatch the aircraft under the one or more affected MEL items and, in the event of a decision to dispatch under the one or more affected MEL items: one or more future missions assigned to the aircraft; for each affected MEL item, one or more dispatch conditions selected from among the one or more applicable dispatch conditions; and one or more possible tasks to be carried out in the aircraft, belonging to the group comprising: one or more system reconfigurations to be carried out, one or more operational limitations to be observed, and one or more inspections or checks to be carried out;
in a third computer, implemented in the aircraft or in an electronic flight bag, and comprising electronic circuitry:
   receiving the proposed scenario from the second computer;
   receiving a decision from an aircraft pilot to accept or reject the proposed scenario; and
   in the event of an acceptance decision, triggering the completion of the one or more possible tasks to be carried out in the aircraft and recording the following in a logbook: said at least one technical fault of the aircraft; a new current operational status of the aircraft indicating the decision to dispatch under the one or more affected MEL items for the one or more future missions assigned to the aircraft; for each affected MEL item, the one or more dispatch conditions selected from among the one or more applicable dispatch conditions; and an execution status of the one or more possible tasks to be carried out in the aircraft.

Thus, the proposed method is executed by first, second and third computers during a current mission of the aircraft during which a technical fault is detected. The first computer automatically determines, as a function of fault information, the technical status of the aircraft and the minimum equipment list, the one or more affected MEL items and, for each item, the one or more applicable dispatch conditions. The second computer automatically determines, as a function of the previous items provided by the first computer (affected MEL items and applicable dispatch conditions) and of a set of future missions to be distributed among a fleet of aircraft, a proposed scenario (including, in the event that dispatch under one or more MEL items is proposed for one or more missions, a selection of dispatch conditions for each affected MEL item). The third computer receives a decision from the pilot to accept or refuse the proposed scenario and, in the event of acceptance, triggers the completion (optionally automatically, as discussed hereafter) of some of the tasks in the aircraft and updates the logbook.

The proposed solution offers several advantages, notably those described hereafter.

It is highly automated, as the method is executed by three computers that interact with each other. Consequently, the proposed solution provides a high degree of anticipation, since the method is executed during the current mission of the aircraft, i.e., before the aircraft lands and the aircraft turn around time (TAT) begins. Consequently, the proposed solution:
overcomes the need for a ground mechanic and avoids affecting the turn around time (TAT) of the aircraft when assessing the possibility of dispatch under an MEL item for the subsequent missions of the aircraft;
anticipates the assessment of the possibility of dispatch under an MEL item; and
allows the operator (airline) to anticipate the maintenance or the adjustment of flight schedules (missions) for its fleet of aircraft; in particular, the operator can optimally distribute a set of future missions across its fleet of aircraft, taking into account, for each aircraft exhibiting a fault during a mission, the one or more affected MEL items and the one or more applicable dispatch conditions. This also reduces the workload of the operator.

It overcomes (partially or completely) the need for a ground mechanic to reconfigure the aircraft in the event of dispatch under an MEL item for the subsequent missions of the aircraft.

It also facilitates the analysis of the situation by the pilots for the subsequent flights of the aircraft when preparing for said subsequent flights.

According to a particular embodiment, in the event of a decision to dispatch under the one or more affected MEL items, the proposed scenario includes, for each affected MEL item, at least one dispatch condition selected from among a group of at least two applicable dispatch conditions that are mutually exclusive.

According to a particular embodiment, the second computer is implemented in a maintenance control centre and/or in an operational control centre.

According to a particular embodiment, in the event of a decision to accept the proposed scenario by the pilot, the third computer triggers the automatic execution of at least one task from among the one or more possible tasks to be carried out in the aircraft.

According to a particular embodiment, the at least one task whose automatic execution is triggered by the third computer corresponds to the one or more system reconfigurations to be carried out.

According to a particular embodiment, the method further comprises, in the third computer: transmitting the decision of the aircraft pilot to the second computer and, in the event of an acceptance decision, transmitting the execution status of the one or more possible tasks to be carried out in the aircraft.

According to a particular embodiment, the database comprising the minimum equipment list is a contextualised database, the content of which:
results from filtering, based on said aircraft, a complete minimum equipment list common to a plurality of aircraft including said aircraft; and
is limited to the information necessary for implementing the method in the first, second third computers.

According to a particular embodiment, the method further comprises, in the first computer:
if the aircraft is already in a current operational state indicating a previous decision to dispatch under at least one MEL item:
   detecting any conflicts of a first type between:
      the one or more items of equipment or the one or more functions of the aircraft that are already considered inoperative because they are affected by the one or more MEL items according to which the previous decision to dispatch was made; and
      the one or more items of equipment or the one or more functions of the aircraft that must be non-inoperative in order to make the one or more dispatch conditions defined in the one or more affected MEL items that the first computer has determined applicable; and
   if a conflict of the first type is detected, for an item of equipment or a function that should be non-inoperative in order to make a given new dispatch condition applicable but that is already considered inoperative, then said given new dispatch condition is declared inapplicable.

According to a particular embodiment, the method further comprises, in the first computer:
if the aircraft is already in a current operational state indicating a previous decision to dispatch under at least one MEL item:
   detecting any conflicts of a second type between:
      the one or more items of equipment or the one or more functions of the aircraft that must be non-inoperative in order to keep applicable one or more dispatch conditions applicable previously selected during a previous iteration of the method, and defined in the one or more MEL items according to which the
      ious decision to dispatch was made; and
   the one or more items of equipment or the one or more functions of the aircraft that are now considered inoperative because they are affected by the one or more affected MEL items that the first computer has determined; and
   if a conflict of the second type is detected, for an item of equipment or a function that should be non-inoperative in order to keep a given previous dispatch condition applicable but that is now considered inoperative, then said given previous dispatch condition is declared inapplicable.

A system is also proposed for assisting in the operational decision-making of an aircraft, the system comprising:
a first computer, implemented in the aircraft or in an electronic flight bag or on the ground, and comprising electronic circuitry configured to implement the operations assigned thereto in the aforementioned method, in any one of the embodiments thereof;
a second computer, installed on the ground and comprising electronic circuitry configured to implement the operations assigned thereto in the aforementioned method, in any one of the embodiments thereof;
a third computer, implemented in the aircraft or in an electronic flight bag, and comprising electronic circuitry configured to implement the operations assigned thereto in the aforementioned method, in any one of the embodiments thereof.

A computer program product is also proposed comprising instructions causing the processors included in the first, second and third computers to execute the aforementioned method, in any one of the embodiments thereof, when said instructions are executed by said processors.

A storage medium storing such instructions is also proposed.

### BRIEF DESCRIPTION OF THE DRAWINGS

The features of the aforementioned invention, as well as other features, will become more clearly apparent upon reading the following description of at least one embodiment, with said description being provided with reference to the accompanying drawings, in which:

FIG. 1 schematically illustrates a system for assisting in the operational decision-making of an aircraft, according to a particular embodiment comprising first and third computers implemented in the aircraft and a second computer implemented on the ground;

FIG. 2 schematically illustrates an example of the hardware architecture of a generic computer, which can correspond to each of the computers in the system of FIG. 1;

FIG. 3 schematically illustrates an example of an algorithm for assisting in the operational decision-making of an aircraft, according to a particular embodiment; and

FIG. 4 schematically illustrates an example of an MEL item.

### DETAILED DISCLOSURE OF EMBODIMENTS

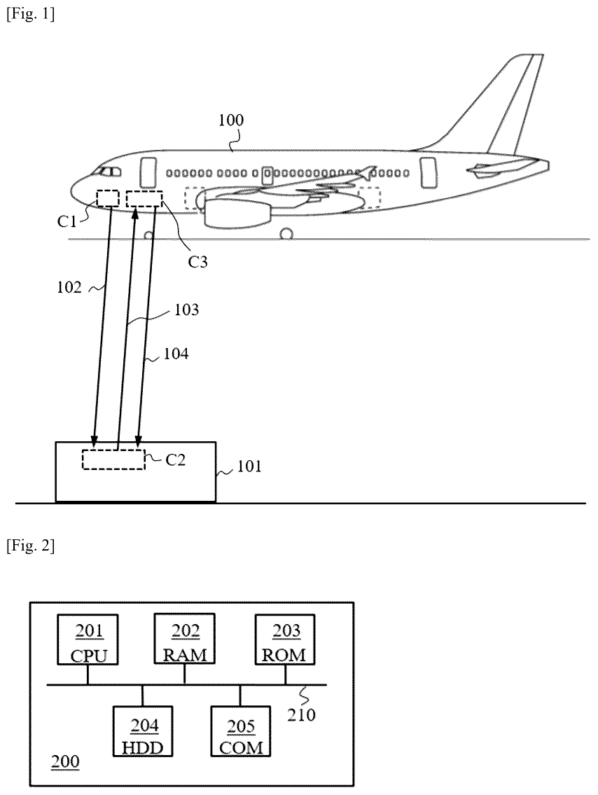

FIG. 1 schematically illustrates a system for assisting in the operational decision-making of an aircraft, according to a particular embodiment comprising first and third computers (reference signs C1 and C3 respectively) implemented in the aircraft 100 and a second computer (reference sign C2) implemented on the ground, in a control centre 101.

The computer C1 and/or the computer C3 is (are), for example, implemented in the flight warning system (FWS) of the aircraft 100, or in another system (or application) capable of exchanging data with the FWS.

The control centre 101 (on the ground), in which the computer C2 is implemented, is, for example, a maintenance control centre (MCC) or an operational control centre (OCC).

In one variant, the computer C1 and/or the computer C3 is (are) implemented in an electronic flight bag (EFB). In another variant, the computers C1 and C3 are combined in the same computer, implemented in the aircraft or in the EFB. In another variant, the computer C1 is implemented on the ground, like the computer C2. In another variant, the computers C1 and C2 are combined in the same computer implemented on the ground.

Each of the computers, C1, C2 and C3 comprises electronic circuitry, an embodiment of which is described hereafter with reference to FIG. 2.

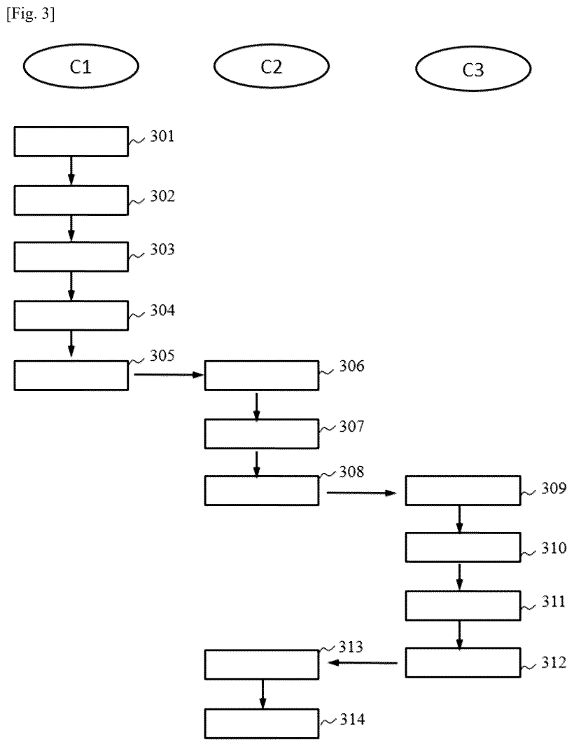

The exchanges between the computers, illustrated by the arrows 102, 103 and 104, are described hereafter with reference to FIG. 3.

FIG. 2 schematically illustrates an example of the hardware architecture of a generic computer 200, which can correspond to each of the computers C1, C2 and C3 of the system of FIG. 1. The computer 200 comprises, connected by a communication bus 210: a processor or CPU (Central Processing Unit) 201; a RAM (Random Access Memory) 202; a ROM (Read Only Memory) 203, for example, a Flash memory; a data storage device, such as a hard disk drive (HDD), or a storage medium reader, such as a Secure Digital (SD) card reader 204; at least one communication interface 205.

The processor 201 is capable of executing instructions loaded into the RAM 202 from the ROM 203, from an external memory (not shown), from a storage medium, such as an SD card, or from a communication network (not shown). When the computer 200 is powered up, the processor 201 is capable of reading instructions from the RAM 202 and of executing them. These instructions form a computer program causing the processor 201 to implement the behaviours, steps and algorithm described herein. Each of the computers C1, C2 and C3 executes a different computer program defining the operations assigned to this computer in the method (algorithm) for assisting in the operational decision-making of an aircraft, for example, according to the embodiment described hereafter with reference to FIG. 3.

All or some of the behaviours, steps and algorithms described herein thus can be implemented in software form by executing a set of instructions using a programmable machine, such as a DSP (“Digital Signal Processor”) or a microcontroller, or can be implemented in hardware form by a dedicated machine or component (“chip”) or a set of dedicated components (“chipset”), such as an FPGA (“Field-Programmable Gate Array”) or an ASIC (“Application-Specific Integrated Circuit”). In general, the computer 200 comprises electronic circuitry arranged and configured to implement the behaviours, steps and algorithms described herein (which differ for each of the computers C1, C2 and C3).

FIG. 3 schematically illustrates an example of an algorithm for assisting in the operational decision-making of an aircraft, according to a particular embodiment.

The algorithm (method) is implemented by the computers C1, C2 and C3, described above with reference to FIGS. 1 and 2. The computer C1 executes steps 301 to 305. The computer C2 executes steps 306 to 308, 313 and 314. The computer C3 executes steps 309 to 312.

It is executed during a current mission of the aircraft 100. Throughout the remainder of the description it is assumed that a technical fault occurs during this current mission.

In step 301, the computer C1 receives fault information indicating at least one technical fault of the aircraft.

In step 302, for each recorded technical fault, the computer C1 determines, by consulting an MEL database (i.e., a database containing a minimum equipment list (MEL)), one or more items from the MEL (called MEL items) that are affected by the technical fault. Each affected MEL item relates to an inoperative item of equipment or function of the aircraft and defines one or more dispatch conditions for the aircraft for a possible future mission.

In an initial implementation, the one or more MEL items affected by the technical fault is/are simply determined based on the receipt of dispatch messages (DMs) that the FWS issues in addition to ECAM alerts. Indeed, in order to determine the DMs, the FWS receives fault data from the systems and analyses this data. The DMs allow direct referral to a single MEL item. In this case, the ECAM alerts are used for the conduct of the current flight and the DMs are used for the impacts on the subsequent flights.

In a second implementation, the one or more MEL items affected by the technical fault is/are determined based on the ECAM alerts.

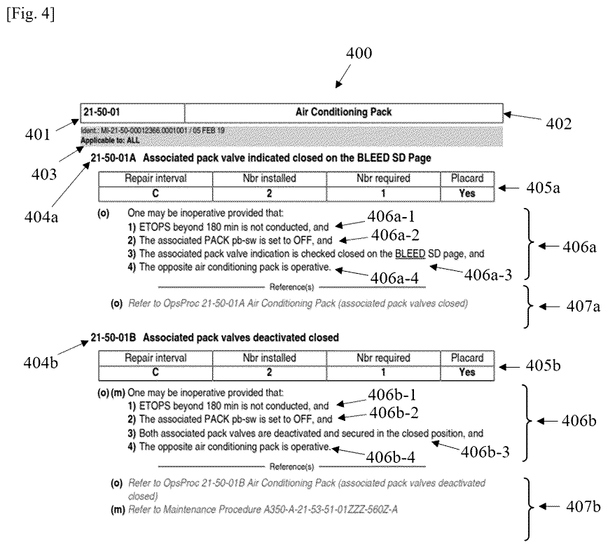

FIG. 4 schematically illustrates an example of an MEL item 400. This example of an MEL item 400 relates to the air conditioning pack and includes an identifier (“21-50-01”), reference sign 401, a description (“Air Conditioning Pack”), reference sign 402, effectiveness information (“Applicable to ALL”), reference sign 403, and two dispatch conditions, reference signs 404a and 404b.

The first dispatch condition 404a itself includes:
an identifier and a description (“21-50-01A” and “Associated pack valve indicated closed on the BLEED SD Page”);
a table 405a comprising:
   the type (in this case “C”) of repair interval;
   the number of occurrences (in this case “2”) of the equipment or function subject to the fault, in this case the air conditioning pack (“Nbr installed”);
   the minimum number (in this case “1”) of occurrences required for an exempted flight (“Nbr required”); and
   an indicator (in this case “Yes”) of the need to affix a label (“Placard”);
a list 406a of conditions (“provisos”) for applying this first dispatch condition, including:
   a first condition (406a-1) of the operational limitation type (in this case: “ETOPS beyond 180 min is not conducted”);
   a second condition (406a-2) of the reconfiguration type (in this case: “The associated PACKpb-sw is set to OFF”);
   a third condition (406a-3) of the check type (in this case: “The associated pack valve indication is checked closed on the BLEED SD page”);
   a fourth condition (406a-4) of the technical condition type formulated with the expression “is operative” (in this case: “The opposite air conditioning pack is operative”); and
a procedure reference 407a (in this case an operational procedure reference (o)).

The second dispatch condition 404b itself comprises:
an identifier and a description (“21-50-01B” and “Associated pack valves deactivated closed”);
a table 405b (identical to table 405a described above for the first dispatch condition 404a);
a list 406b of conditions (“provisos”) for applying this second dispatch condition, comprising:
   a first condition (406b-1) of the operational limitation type and a second condition (406b-2) of the reconfiguration type (respectively identical to the first 406a-1 and second 406a-2 conditions of the list 406a described for the first dispatch condition 404a);
   a third condition (406b-3) of the reconfiguration type (in this case: “Both associated pack valves are deactivated and secured in the closed position”);
   a fourth condition (406b-4) of the technical condition type formulated with the expression “is operative” (identical to the fourth condition 406a-4 of the list 406a described for the first dispatch condition 404a); and
two procedure references 407b (in this case an operational procedure reference (o) and a maintenance procedure reference (m)).

Prior to the method described herein, the MEL database was stored on board the aircraft 100. It can be common to all aircraft of the same type operated by the airline. It is updated regularly.

In a particular embodiment, in order to make computer reading of the information faster, the MEL database is a contextualised database, denoted cMEL, whose content is the result of filtering, based on the aircraft 100 (i.e., according to its MSN, or Manufacturer Serial Number), of a complete MEL common to a plurality of aircraft including this aircraft 100. To perform this filtering, the effectiveness is sought in the “applicability” field of the MEL. In addition, the content of the cMEL is limited to the information required for implementing the method in the first, second and third computers. For example, a new contextualised MEL database is created each time the MEL database is updated.

Further reference will now be made to the description of FIG. 3.

In step 303, the computer C1 receives a technical status of the aircraft, including technical data relating to equipment or function faults of the aircraft.

In step 304, for each affected MEL item, the computer C1 determines, based on the technical status of the aircraft, one or more applicable dispatch conditions from among the one or more dispatch conditions defined in this affected MEL item.

As already explained above with reference to FIG. 4, each MEL item includes one or more dispatch conditions and each dispatch condition itself includes a list of conditions (provisos)

for applying this dispatch condition. In one embodiment, the list of conditions (provisos) is encoded in the contextualised MEL database cMEL, so that the MEL data is encoded in computer form and can be computed. Each condition in the list of conditions (provisos), which is of the technical condition type formulated with the expression “is operative” (i.e., relating to a system (equipment or function) that must be operational (not inoperative) in order to apply this dispatch condition, is expressed in the cMEL as an MEL item of the “NOGO_IF” type. If the considered aircraft is already under this MEL item of the “NOGO_IF” type, then the dispatch condition cannot be applicable. All the MEL items for the considered aircraft, as well as the MEL items of the NOGO_IF type for applicable dispatch conditions, are stored in a non-volatile memory in a table of active MEL items (for example, called “active DMs file”).

In a particular embodiment of step 304, the computer C1 performs an automatic conflict analysis (of a first type and/or of a second type) if the aircraft is already under one or more MEL items, i.e., if the aircraft is already in a normal operating state indicating a previous decision to dispatch under at least one MEL item (with this previous decision to dispatch having been accepted by the aircraft pilot before take-off for the current mission).

Conflicts of the first type are conflicts between:
the one or more items of equipment or the one or more functions of the aircraft that are already considered inoperative because they are affected by the one or more MEL items under which the previous decision to dispatch was made; and
the one or more items of equipment or the one or more functions of the aircraft that must be inoperative to make the one or more dispatch conditions defined in the one or more affected MEL items applicable, as determined by the computer C1.

If a conflict of the first type is detected by the computer C1, for an item of equipment or a function that should be non-inoperative to make a given new dispatch condition applicable but is already considered inoperative, then this given new dispatch condition is declared inapplicable.

Conflicts of the second type are conflicts between:
the one or more items of equipment or the one or more functions of the aircraft that must be non-inoperative to keep applicable one or more of the dispatch conditions previously selected during a previous iteration of the method (executed during a previous mission of this aircraft), and defined in the one or more MEL items under which the previous decision to dispatch was made; and
the one or more items of equipment or the one or more functions of the aircraft that are now considered inoperative because they are affected by the one or more affected MEL items that the computer C1 has determined.

If a conflict of the second type is detected by the computer C1, for an item of equipment or a function that should be non-inoperative in order to keep a given previous dispatch condition applicable but that is now considered inoperative, then this given previous dispatch condition is declared inapplicable.

In step 305, the computer C1 transmits the items determined in step 304 to the computer C2. This exchange from the computer C1 to the computer C2 is illustrated in FIG. 1 by the arrow 102.

The execution of steps 301 to 305 by the computer C1 therefore amounts to performing a technical dispatch assessment (TDA).

In step 306, the computer C2 receives the one or more applicable dispatch conditions from the computer C1 for each affected MEL item.

In step 307, the computer C2 determines a proposed scenario based, on the one hand, on the one or more dispatch conditions applicable to each affected MEL item and, on the other hand, on a set of future missions to be distributed across a fleet of aircraft including the aircraft 100 (the aircraft performing the current mission).

The proposed scenario includes:
a decision to repair the aircraft (for example, following an upstream analysis of the operational impact of dispatch under one or more MEL items) or to dispatch with the one or more affected MEL items; and
in the event of a decision to dispatch under the one or more affected MEL items:
   one or more future missions assigned to the aircraft;
   for each affected MEL item, one or more dispatch conditions selected from the one or more applicable dispatch conditions; and
   one or more possible tasks to be carried out in the aircraft, belonging to the group comprising:
      one or more system reconfigurations to be carried out (automatically or by the pilot);
      one or more operational limitations to be observed (for example, no ETOPS (Extended-range Twin-engine Operational Performance Standards), no icing conditions, increased fuel consumption, etc.); and
      One or more inspections or checks to be carried out.

In a particular embodiment, the proposed scenario includes, for each affected MEL item, at least one dispatch condition selected from a group of at least two applicable dispatch conditions that are mutually exclusive.

In step 308, the computer C2 transmits the items determined in step 307 to the computer C3. This exchange from the computer C2 to the computer C3 is illustrated in FIG. 1 by the arrow 103.

The execution of steps 306 to 308 by the computer C2 therefore amounts to performing an operational dispatch assessment (ODA), as well as decision making.

In step 309, the computer C3 receives the proposed scenario from the computer C2.

In step 310, the computer C3 receives (via a human-machine interface) a decision from the aircraft pilot to accept or reject the proposed scenario.

In step 311, if the decision is to accept, the computer C3 triggers the execution of the one or of any tasks to be carried out in the aircraft. At the end of the flight, the following items are recorded in the aircraft logbook (either manually by the pilot or automatically):
the at least one technical fault of the aircraft;
a new current operational status of the aircraft, indicating the decision to dispatch under the one or more affected MEL items for the one or more future missions assigned to the aircraft;
for each affected MEL item, the one or more dispatch conditions selected from the one or more applicable dispatch conditions; and
an execution status (which can, for example, assume one of the following values:
“completed and correct”, “not started”, “failed” and “pending”) of the one or of any tasks to be carried out in the aircraft.

Thus, the pilots of subsequent flights (subsequent missions) of the aircraft will consult the logbook and check the status of the aircraft, the operational limitations, the requirements to recompute the performance capability and will take note of the manual operating procedures (o) to be carried out. By way of a reminder, in a particular implementation, some operational procedures (o) will be initiated automatically, in addition to the standard operating procedures (SOPs).

In a particular embodiment of step 311, the computer C3 triggers the automatic execution (during the current flight) of at least one task (from among the one or more possible tasks to be carried out in the aircraft for dispatch under one or more MEL items for the next mission), for example, the one or more system reconfigurations to be carried out (for example, closing a valve or opening an electronic circuit breaker (eC/B)). The one or more operational procedures (o) will be executed during subsequent flights.

In step 312, the computer C3 transmits the decision of the aircraft pilot to the computer C2 and, if the decision is to accept, the execution status of the one or of any tasks to be carried out in the aircraft. This exchange from the computer C3 to the computer C2 is illustrated in FIG. 1 by the arrow 104.

In step 313, the computer C2 receives the items from the computer C3 that were transmitted by the computer C3 in step 312.

In step 314, the computer C2 (and therefore the control centre 101 (MCC or OCC, for example) records, for example, in a table, the fact that the aircraft has been dispatched or has remained on the ground for repair, and, if it has been dispatched, it also records the fact that this is a dispatch under one or more MEL items, specifying the one or more dispatch conditions that have been selected (optionally with the operational impacts). The manual tasks that are still to be carried out are also recorded. Once these have been carried out, the imposition of the MEL can be considered to be effective. Thus, the control centre 101 can then schedule the repair before the end of the authorised interval.

1. A method for assisting in the operational decision-making of an aircraft, the method being executed during a current mission of the aircraft and comprising:
in a first computer implemented in the aircraft or in an electronic flight bag or on the ground, and comprising electronic circuitry:
receiving fault information recording at least one technical fault of the aircraft;
for each recorded technical fault, determining, by consulting a database comprising a minimum equipment list, one or more items from the minimum equipment list, called MEL items, affected by said technical fault, with each affected MEL item relating to an inoperative item of equipment or function of the aircraft and defining one or more dispatch conditions for the aircraft for a possible future mission;
receiving a technical status of the aircraft, including technical data relating to the operation of equipment or functions of the aircraft; and
for each affected MEL item, determining, based on the technical status of the aircraft, one or more applicable dispatch conditions from among the one or more dispatch conditions defined in said affected MEL item;
in a second computer installed on the ground and comprising electronic circuitry:
receiving, from the first computer the one or more applicable dispatch conditions for each affected MEL item; and
determining a proposed scenario based, on the one hand, on the one or more dispatch conditions applicable for each affected MEL item and, on the other hand, on a set of future missions to be distributed among a fleet of aircraft including said aircraft, said proposed scenario comprising: a decision to repair the aircraft or to dispatch the aircraft under the one or more affected MEL items and, in the event of a decision to dispatch under the one or more affected MEL items: one or more future missions assigned to the aircraft; for each affected MEL item, one or more dispatch conditions selected from among the one or more applicable dispatch conditions; and one or more possible tasks to be carried out in the aircraft, belonging to the group comprising: one or more system reconfigurations to be carried out, one or more operational limitations to be observed, and one or more inspections or checks to be carried out;
in a third computer, implemented in the aircraft or in an electronic flight bag, and comprising electronic circuitry:
receiving the proposed scenario from the second computer;
receiving a decision from an aircraft pilot to accept or reject the proposed scenario; and
in the event of an acceptance decision, triggering the completion of the one or more possible tasks to be carried out in the aircraft and recording the following in a logbook: said at least one technical fault of the aircraft; a new current operational status of the aircraft indicating the decision to dispatch under the one or more affected MEL items for the one or more future missions assigned to the aircraft; for each affected MEL item, the one or more dispatch conditions selected from among the one or more applicable dispatch conditions; and an execution status of the one or more possible tasks to be carried out in the aircraft.

2. The method according to claim 1, wherein, in the event of a decision to dispatch under the one or more affected MEL items, the proposed scenario includes, for each affected MEL item, at least one dispatch condition selected from among a group of at least two applicable dispatch conditions that are mutually exclusive.

3. The method according to claim 1, wherein the second computer is implemented in a maintenance control centre and/or in an operational control centre

4. The method according to claim 1, wherein, in the event of a decision to accept the proposed scenario by the pilot, the third computer triggers the automatic execution of at least one task from among the one or more possible tasks to be carried out in the aircraft.

5. The method according to claim 4, wherein the at least one task whose automatic execution is triggered by the third computer corresponds to the one or more system reconfigurations to be carried out.

6. The method according to claim 1, further comprising, in the third computer:
transmitting the decision of the aircraft pilot to the second computer and, in the event of an acceptance decision, transmitting the execution status of the one or more possible tasks to be carried out in the aircraft.

7. The method according to claim 1, wherein the database comprising the minimum equipment list is a contextualised database, the content of which:
results from filtering, based on said aircraft, a complete minimum equipment list common to a plurality of aircraft including said aircraft; and
is limited to the information necessary for implementing the method in the first, second and third computers.

8. The method according to claim 1, further comprising, in the first computer
if the aircraft is already in a current operational state indicating a previous decision to dispatch under at least one MEL item:
detecting any conflicts of a first type between:
the one or more items of equipment or the one or more functions of the aircraft that are already considered inoperative because they are affected by the one or more MEL items according to which the previous decision to dispatch was made; and
the one or more items of equipment or the one or more functions of the aircraft that must be non-inoperative in order to make the one or more dispatch conditions defined in the one or more affected MEL items that the first computer has determined applicable; and
if a conflict of the first type is detected, for an item of equipment or a function that should be non-inoperative in order to make a given new dispatch condition applicable but that is already considered inoperative, then said given new dispatch condition is declared inapplicable.

9. The method according to claim 1, further comprising, in the first computer:
if the aircraft is already in a current operational state indicating a previous decision to dispatch under at least one MEL item:
detecting any conflicts of a second type between:
the one or more items of equipment or the one or more functions of the aircraft that must be non-inoperative in order to keep applicable one or more dispatch conditions previously selected during a previous iteration of the method, and defined in the one or more MEL items according to which the previous decision to dispatch was made; and
the one or more items of equipment or the one or more functions of the aircraft that are now considered inoperative because they are affected by the one or more affected MEL items that the first computer has determined; and
if a conflict of the second type is detected, for an item of equipment or a function that should be non-inoperative in order to keep a given previous dispatch condition applicable but that is now considered inoperative, then said given previous dispatch condition is declared inapplicable

10. A Ssystem for assisting in the operational decision-making of an aircraft, the system comprising:
a first computer implemented in the aircraft or in an electronic flight bag or on the ground, and comprising electronic circuitry configured to implement the operations assigned thereto in the method according to claim 1;
a second computer installed on the ground and comprising electronic circuitry configured to implement the operations assigned thereto in the method according to claim 1; and
a third computer, implemented in the aircraft or in an electronic flight bag, and comprising electronic circuitry configured to implement the operations assigned thereto in the method according to claim 1.

11. (canceled)
